(19) United States
(12) Patent Application Publication
(10) Pub. No.: US 2022/0199318 A1
(43) Pub. Date: Jun. 23, 2022

(54) ELECTRICAL SELF-INDUCTION TRANSFORMER

(71) Applicant: Amine AMEKRANE, Nador (MA)

(72) Inventor: Amine AMEKRANE, Nador (MA)

(21) Appl. No.: 17/600,948

(22) PCT Filed: Mar. 30, 2020
(86) PCT No.: PCT/MA2020/000003

§ 371 Date: Oct. 1, 2021

(30) Foreign Application Priority Data
Apr. 1, 2019 (MA) 45366

(51) Int. Cl. H01F 30/10; H01F 27/00

(52) U.S. Cl. CPC H01F 30/10; H02P 13/12; H01F 27/004

(57) ABSTRACT

The invention relates to a self-induction transformer which includes:
At least two magnetic circuits (4 and 5) in connection, and at least three electrical windings (1, 2 and 3):
The primary (1) which surrounds the free part of the first magnetic circuit.
The secondary (2) which surrounds the linking part of the two magnetic circuits.
The tertiary (3) which surrounds the free part of the second magnetic circuit

In order to vary the output voltage of an electrical transformer, we act on the input voltage or on the number of turns.

In this invention, one of these functions is to increase the output voltage by acting on the current flowing in a tertiary winding and to regulate it according to this current.

The invention relates to a self-inducting electrical transformer, comprising at least two linked closed magnetic circuits (4 and 5) and at least three windings (1, 2 and 3), a winding (1) whose core is the free part of the first magnetic circuit (4), a winding (2) whose core is the linking part of the two magnetic circuits (4 and 5) and a winding (3) whose core is the free part of the second magnetic circuit (5).

The linked magnetic circuits (4 and 5) are separated from each other at the end of the linking part, on both sides of the linked part, to form the free part.

The ends of the free part of the same magnetic circuit are directed towards each other before entering the linking part to form a closed circuit.

The ends of the linked magnetic circuits on one side are tending to have the same direction before entering the linking part.

A magnetic circuit may have several linking parts and each part may contain several linked magnetic circuits.

The magnetic flux generated by the flow of electric current in the winding surrounding the free part exits from one end and re-enters from the other end of the same magnetic circuit through the linking part of the linked magnetic circuits, without reaching the rest of the linked magnetic circuits.

The magnetic flux generated by the flow of electric current in the winding surrounding the linking part is distributed over the magnetic circuits of which it surrounds the linking part, and it flows only in the magnetic circuits of which it surrounds the linking part and the linking parts of the neighbouring magnetic circuits if these magnetic circuits have several linking parts.

This invention is a reversible self-induction electrical transformer, in which the function of the primary (1) can be alternated between the primary (1) and the tertiary (3) or a winding of the free part of a magnetic circuit when there are more than two magnetic circuits, and the function of the secondary (2) will be performed by the windings surrounding the linking part of the magnetic circuits.

This description describes the single-phase operation of the invention, the invention works in the same way in multi-phase for each phase.

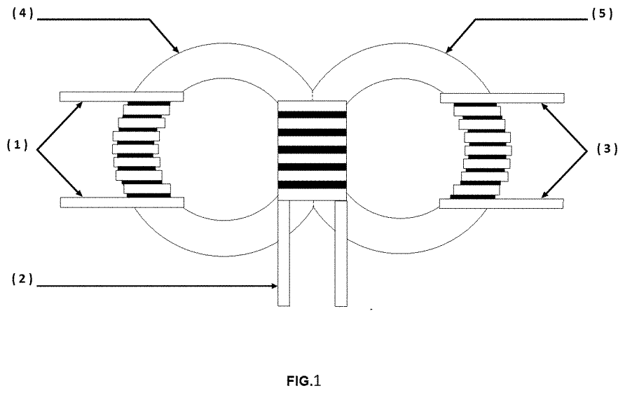

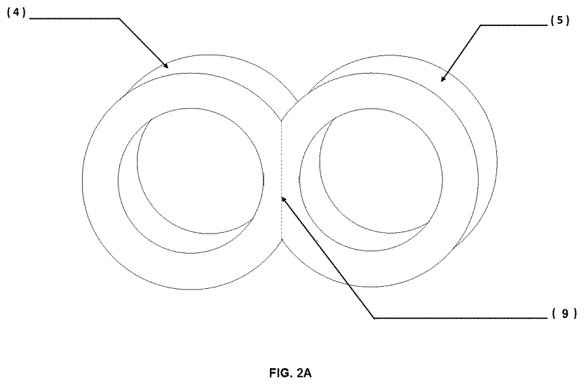

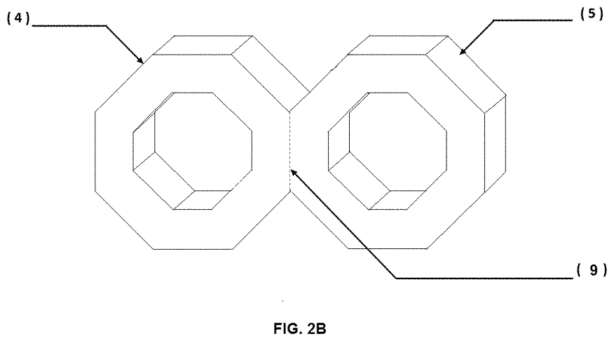

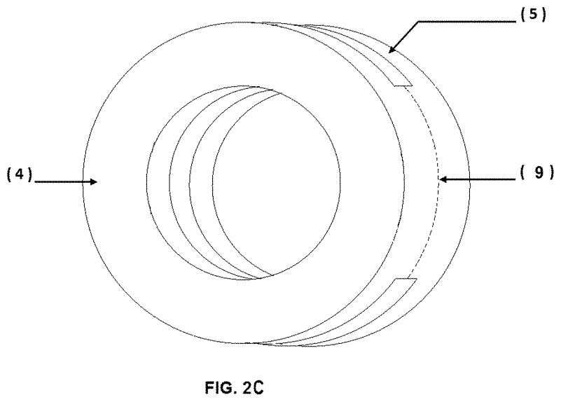

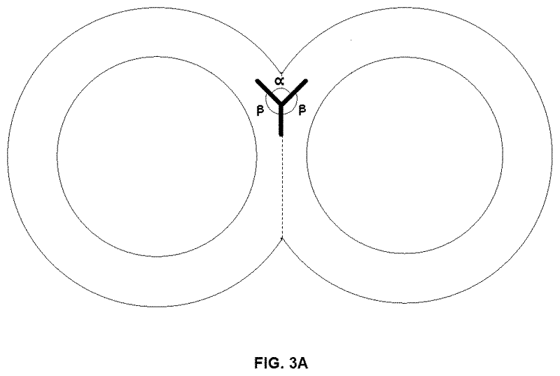

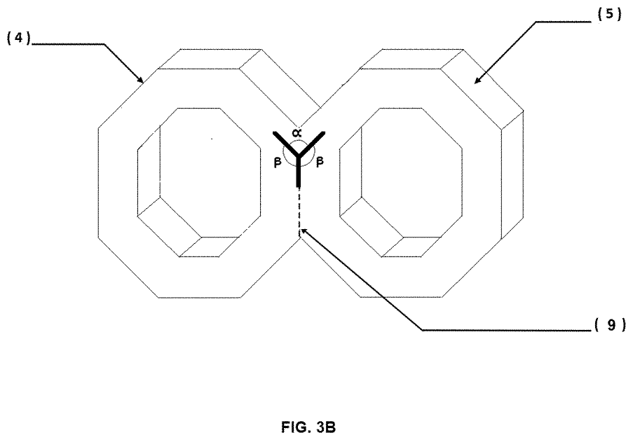

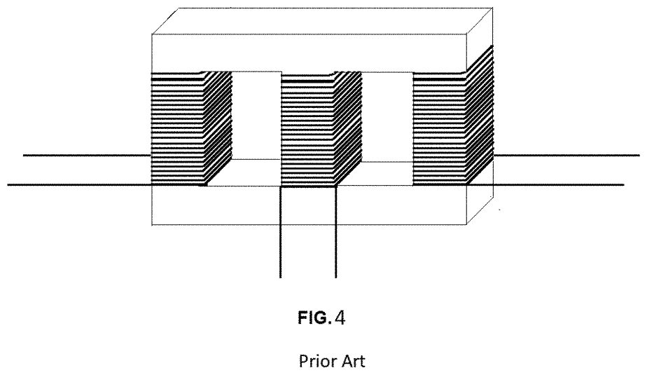

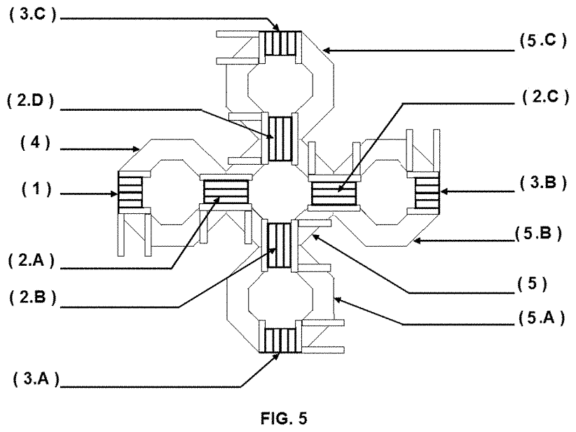

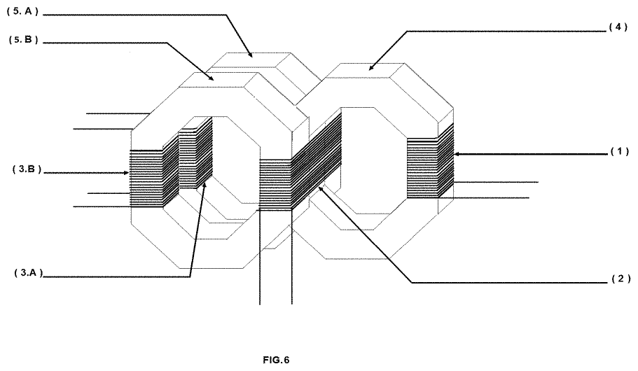

The drawing in FIG. 1 shows the case of a self-induction electrical transformer with two magnetic circuits and three windings only. This is an example, the application of this invention is not limited to this example.

This invention can be used as an electrical transformer with a regulated output voltage across the secondary (2) depending on the current delivered by the tertiary (3), its operating principle is as follows:

At the level of the electrical circuits:

In a first step, the secondary winding (2) of the linking part operates as an armature, when one of the primary windings (1) surrounding the free part of one of the magnetic circuits is inductive.

In a second step, the secondary winding (2) of the linking part operates as an armature and an inductor at the same time. When it delivers a current, it induces a voltage across the tertiary winding (3) surrounding the free part of the other magnetic circuit.

In a third stage, when a current is supplied by the tertiary winding (3) which acts as an armature to the secondary winding (2) surrounding the linking part, the latter reacts by increasing its power to respond to the power supplied by the tertiary winding (3), resulting in an increase in the voltage supplied to the ends of the secondary winding (2), without increasing the voltage of its inductor (1)

At the level of the magnetic circuits:

Firstly, when the primary (1) is subjected to an alternating or pulsating voltage U₁, an alternating current I₁ flows through it, creating a variable magnetic flux φ₁ in the first magnetic circuit (4), which induces a voltage U₂ at the terminals of the secondary (2) surrounding the linking part of the magnetic circuits (4 and 5).

Secondly, as soon as a load is supplied with the voltage U₂ from the secondary (2), a current I₂ flows in the secondary (2), giving rise to a magnetic flux φ₂, part of which resists the flux φ₁ of the first magnetic circuit (4) which gives rise to it and part of which magnetises the second magnetic circuit (5), which induces a voltage U3 at the terminals of the tertiary winding (3).

Thirdly, when a load is supplied with the voltage U₃ from the tertiary (3), a current I₃ flows in the tertiary (3), which generates a resistive magnetic flux φ₃ in the second magnetic circuit (5) that opposes the cause it gives rise to, i.e. the flux φ₂ generated by the current flow in the secondary (2). This is in addition to the inductive magnetic flux φ₁ generated by the flow of current in the primary (1), as it passes through the linking part of the magnetic circuits (4 and 5), intensifying the magnetic flux in the linking part, thereby increasing the voltage at the terminals of the secondary winding (2) which surrounds this part.

According to the application, the power balance of this invention is:

The input power is the power absorbed by the primary (1)

The output power is the sum of the powers supplied by the secondary (2) and tertiary (3) independently in the case of two magnetic circuits, if there are more than two magnetic circuits simply adding the powers of the other windings to those of the secondary (2) and tertiary (3).

1. The invention relates to a self-inducting electrical transformer, comprising at least two linked closed magnetic circuits (4 and 5) and at least three windings (1, 2 and 3), a winding (1) whose core is the free part of the first magnetic circuit (4), a winding (2) whose core is the linking part of the two magnetic circuits (4 and 5) and a winding (3) whose core is the free part of the second magnetic circuit (5).

2. According to claim 1, the electrical transformer is characterised in that the magnetic circuits (4 and 5) in connection are separated from each other at the end of the linking part, and this on both sides of the linked part, to form the free part.

3. According to the preceding claims, the electrical transformer is characterised in that the ends of the free part of the same magnetic circuit are directed towards each other before entering the linking part to form a closed circuit.

4. According to the preceding claims, the electrical transformer is characterised in that the ends of the linked magnetic circuits on one side are tending to have the same direction before entering the linking part.

5. According to the preceding claims, the electrical transformer is characterised in that a magnetic circuit may have several linking parts and each part may contain several linked magnetic circuits.

6. According to the preceding claims, the electric transformer is characterised in that the magnetic flux generated by the flow of electric current in the winding surrounding the free part exits from one end and re-enters from the other end of the same magnetic circuit through the linking part of the linked magnetic circuits, without reaching the rest of the linked magnetic circuits.

7. According to the preceding claims, the electrical transformer is characterised in that the magnetic flux generated by the flow of electrical current in the winding surrounding the linking part is distributed over the magnetic circuits of which it surrounds the linking part and flows only in the magnetic circuits of which it surrounds the linking part and the linking parts of the neighbouring magnetic circuits if these magnetic circuits have several linking parts.

8. The electrical transformer according to the preceding claims, is characterised in that this invention is a reversible electrical transformer, of which the function of the primary (1) can alternate between the primary (1) and the tertiary (3) or a winding of the free part of a magnetic circuit if there are several magnetic circuits, and the function of the secondary (2) will be performed by the windings surrounding the linking part of the magnetic circuits.

9. The electrical transformer according to the preceding claims, is characterised in that the invention operates in the same way in multi-phase for each phase.
